(19) United States
(12) Patent Application Publication
(10) Pub. No.: US 2017/0346070 A1
(43) Pub. Date: Nov. 30, 2017

(54) POSITIVE ELECTRODE FOR RECHARGEABLE LITHIUM BATTERY AND RECHARGEABLE LITHIUM BATTERY INCLUDING SAME

(71) Applicant: Samsung SDI Co., Ltd., Yongin-si (KR)

(72) Inventors: Ji-Hyun Kim, Yongin-si (KR); Chang-Wook Kim, Yongin-si (KR)

(21) Appl. No.: 15/606,996

(22) Filed: May 26, 2017

(30) Foreign Application Priority Data
May 27, 2016 (KR) 10-2016-0065722

(51) Int. Cl. H01M 4/131; H01M 4/525; H01M 4/36; B01J 20/20; H01M 4/136; B01J 20/28; H01M 4/62; H01M 4/505

(52) U.S. Cl. CPC H01M 4/131; H01M 4/624; H01M 4/525; H01M 4/505; B01J 20/20; H01M 4/136; B01J 20/28054; B01J 20/2803; H01M 4/364

(57) ABSTRACT

A positive electrode for a rechargeable lithium battery and a rechargeable lithium battery including the same. The positive electrode may include a current collector and a positive active material layer on the current collector, wherein the positive active material layer may include a positive active material and a Fe-containing oxide, and the Fe-containing oxide is included in an amount of about 0.015 parts by weight to about 8.5 parts by weight based on 100 parts by weight of the positive active material.

### CROSS-REFERENCE TO RELATED APPLICATION

This application claims priority to and the benefit of Korean Patent Application No. 10-2016-0065722 filed in the Korean Intellectual Property Office on May 27, 2016, the entire content of which is incorporated herein by reference.

### BACKGROUND

One or more aspects of example embodiments of the present disclosure are related to a positive electrode for a rechargeable lithium battery and a rechargeable lithium battery including the same.

Rechargeable lithium batteries have recently drawn attention as power sources for small portable electronic devices. Rechargeable lithium batteries use an organic electrolyte solution, and thereby have discharge voltages that are at least twice as high as alkali batteries using an aqueous electrolyte solution. Accordingly, rechargeable lithium batteries may have high energy densities.

A lithium-transition metal oxide having a structure capable of intercalating lithium ions (such as LiCoO₂, LiMn₂O₄, LiNi₁₋ₓCoₓO₂ (0<x<1), and/or the like) has been used as positive active materials.

Various carbon-based negative active materials (such as artificial graphite, natural graphite, and/or hard carbon), and oxide negative active materials (such as tin oxide, lithium vanadium-based oxide, and/or the like), which intercalate and deintercalate lithium ions, have been used as negative active materials.

### SUMMARY

One or more aspects of example embodiments of the present disclosure are directed toward a positive electrode for a rechargeable lithium battery having an increased lithium utilization ratio.

One or more aspects of example embodiments of the present disclosure are directed toward a rechargeable lithium battery having high capacity due to the positive electrode.

One or more example embodiments of the present disclosure provide a positive electrode for a rechargeable lithium battery including a current collector and a positive active material layer on the current collector, wherein the positive active material layer includes a positive active material and a Fe-containing oxide, and the Fe-containing oxide is included in an amount of about 0.015 parts by weight to about 8.5 parts by weight based on 100 parts by weight of the positive active material.

The Fe-containing oxide may be Li₅FeO₄, LiFeO₂, LiFe₅O₈, or a combination thereof.

The positive active material layer may include about 0.08 parts by weight to about 4.0 parts by weight of the Fe-containing oxide per 100 parts by weight of the positive active material.

The Fe-containing oxide may have a particle diameter (D50) of about 0.5 μm to about 3 μm.

The positive active material may be a compound represented by Chemical Formula 1:

LiₐCo_{1-b}M_{b}O₂. Chemical Formula 1

In Chemical Formula 1, 0.90≦a≦0≦b≦0.5, and M may be selected from Al, Ni, Co, Mn, Cr, Fe, Mg, Sr, V, a rare earth element, and a combination thereof.

One or more example embodiments of the present disclosure provide a rechargeable lithium battery including a positive electrode including a positive active material and Fe, a negative electrode including a negative active material, and an electrolyte, wherein the Fe is included in an amount of about 0.005 wt % to about 3 wt % based on 100 wt % of the positive active material.

The rechargeable lithium battery may include a positive electrode including a current collector and a positive active material layer on the current collector, wherein the positive active material layer may include a positive active material and an Fe-containing oxide, and the Fe-containing oxide may be included in an amount of about 0.015 parts by weight to about 8.5 parts by weight based on 100 parts by weight of the positive active material, and the rechargeable lithium battery may be manufactured by performing 1 to 3 charge/discharge cycles at about 0.05 C to about 0.1 C.

The negative active material may be a carbon-based negative active material.

Other embodiments are included in the following detailed description.

The positive electrode for a rechargeable lithium battery according to an embodiment of the present disclosure may exhibit an improved lithium utilization ratio and provide a rechargeable lithium battery having high capacity.

### BRIEF DESCRIPTION OF THE DRAWINGS

FIG. 1 is a schematic view showing a structure of a positive active material according to an embodiment of the present disclosure.

FIG. 2 is a graph showing capacity utilization ratio of the cells according to Examples 1 to 10 and Comparative Examples 1, 4, and 5.

### DETAILED DESCRIPTION

The present disclosure will be described more fully hereinafter with reference to the accompanying drawings, in which example embodiments of the disclosure are shown. As those skilled in the art would realize, the described embodiments may be modified in various different ways, all without departing from the spirit or scope of the present disclosure.

In the drawings, the thicknesses of layers, films, panels, regions, etc., may be exaggerated for clarity. Like reference numerals designate like elements throughout the specification, and duplicative descriptions thereof may not be provided. It will be understood that when an element such as a layer, film, region, or substrate is referred to as being “on” another element, it can be directly on the other element or intervening element(s) may also be present. In contrast, when an element is referred to as being “directly on” another element, no intervening elements are present.

A positive electrode for a rechargeable lithium battery according to an embodiment of the present disclosure includes a current collector and a positive active material layer on the current collector, wherein the positive active material layer includes a positive active material and a Fe-containing oxide, and the Fe-containing oxide may be included in an amount of about 0.015 parts by weight to about 8.5 parts by weight based on 100 parts by weight of the positive active material.

The positive active material layer may be included in an amount of about 0.08 parts by weight to about 4.0 parts of the Fe-containing oxide by weight based on 100 parts by weight of the positive active material.

In general, when a battery is manufactured using lithium cobalt-based oxide as a positive active material and a carbon-based material (such as graphite) as a negative active material, the battery may be designed according to the initial charge and discharge efficiency of the negative electrode, because the initial efficiency of the negative electrode is lower than that of the positive electrode. However, in order to obtain maximum battery capacity, the positive and negative electrodes may be designed to have similar irreversible capacities. In other words, battery capacity may be calculated by subtracting the maximum irreversible capacity of the positive or negative electrode from the charge capacity of the positive electrode. Example embodiments of the present disclosure are directed toward decreasing the irreversible capacity of the positive electrode.

A portion of the Li included in the positive active material may participate in forming an SEI (solid electrolyte interface or solid electrolyte interphase) film on the surface of the negative electrode during charge and discharge. This portion of the Li is converted into irreversible Li, which does not participate in further charge and discharge reactions (e.g., cycles). Accordingly, the battery capacity may be decreased (e.g., proportionally to the amount of irreversible Li). The Fe-containing oxide according to an embodiment of the present disclosure may play the role of a sacrificial positive electrode compound in compensating the irreversible Li by providing Li and decomposing during the formation process, but not participating in subsequent charge and discharge processes. For example, when Li₅FeO₄ is used as the Fe-containing oxide, Li₅FeO₄ may be decomposed between 3.7 V to 3.9 V (relative to Li⁺/Li) to provide four Li's (e.g., Li⁺ ions). When the Fe-containing oxide is used at a suitable amount, the Fe-containing oxide may sufficiently compensate for the irreversible Li, and may thus increase the utilization ratio of the positive active material. When the Fe-containing oxide is used in a smaller amount, the irreversible Li may not be sufficiently compensated, but when the Fe-containing oxide is used in an excessive amount, the utilization ratio of the positive electrode may be rather (e.g., substantially) decreased.

When Li₆MnO₄ is used instead of the Fe-containing oxide, the Li₆MnO₄ may have remarkably lower (e.g., substantially less suitable) electrochemical characteristics than the Fe-containing oxide, and thus may not obtain a suitable or desired effect. When Li₆CoO₄ is used, the Li₆CoO₄ may decompose during charge and discharge to form Li₂O and CoO, the CoO may dissolve in an electrolyte to form Co²⁺, and Co may precipitate at the negative electrode, thus inappropriately deteriorating the battery characteristics.

The Fe-containing oxide may be Li₅FeO₄, LiFeO₂, LiFe₅O₈, or a combination thereof. Li₅FeO₄ may provide more Li than the others and thereby compensate for more irreversible Li during the formation process and thus enhance an effect of the sacrifice positive electrode.

The Fe-containing oxide may have a particle diameter (D50) of about 0.5 μm to about 3 μm. When the Fe-containing oxide has a particle diameter (D50) within this range, the density of the active mass may be substantially improved during manufacture of a positive electrode. In the specification, D50 may be determined using a laser diffraction technique with PSA (Mastersizer 2000, Malvern instruments) equipment.

As used herein, the term ‘active mass’ indicates a mixture of an active material, a binder, and a conductive material. The mixture (e.g., the active mass) is suspended in a solvent to obtain a slurry type active material composition (e.g., active material slurry), and this active material composition is coated on a current collector and then dried to form an active material layer, which may be referred to as an ‘active mass layer’. The terms ‘active mass’ and the ‘active mass layer’ are widely known and thus will not be illustrated in more detail.

As used herein, the term ‘density of an active mass’ indicates the active mass weight per unit volume of an electrode.

As used herein, when a definition is not otherwise provided, the term ‘particle diameter (D50)’ indicates the diameter of a particle having a volume of about 50 volume % in a particle distribution.

The positive active material may be a compound represented by Chemical Formula 1:

LiₐCo_{1-b}M_{b}O₂. Chemical Formula 1

In Chemical Formula 1, 0.90≦a≦0≦b≦0.5, and M may be selected from aluminum (Al), nickel (Ni), cobalt (Co), manganese (Mn), chromium (Cr), iron (Fe), magnesium (Mg), strontium (Sr), vanadium (V), a rare earth element, and combinations thereof.

When a compound represented by the above Chemical Formula 1 is used as a positive active material, a larger amount of irreversible Li may be generated, and a larger amount of the Fe-containing oxide may be used for the positive electrode to maximize the effect of compensating the irreversible Li.

The positive active material may have an average particle diameter (D50) of about 15 μm to about 23 μm. When the positive active material has an average particle diameter (D50) within this range, this positive active material may increase the active mass density of the positive electrode, and resultantly substantially increase the energy density of a battery.

The positive active material layer may further include a binder and a conductive material. When the positive active material layer further includes the binder and the conductive material, the positive active material and the Fe-containing oxide may be used in an amount (e.g., a total amount) of 90 wt % to 98 wt % based on the total amount of the positive active material layer. Herein, the Fe-containing oxide may be mixed in an amount of about 0.015 parts by weight to about 8.5 parts by weight based on 100 parts by weight of the positive active material.

The amount of the binder may be about 1 wt % to about 5 wt % based on the total amount of the positive active material layer, and the amount of the conductive material may be about 1 wt % to about 5 wt % based on the total amount of the positive active material layer.

The binder may improve the binding properties of the positive active material particles with one another and with a current collector. Non-limiting examples of the binder may include polyvinyl alcohol, carboxymethyl cellulose, hydroxypropyl cellulose, diacetyl cellulose, polyvinylchloride, carboxylated polyvinylchloride, polyvinyl fluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and/or the like.

The conductive material may be included to provide or increase electrode conductivity. Any electrically conductive material may be used as a conductive material unless it causes a chemical change (e.g., unwanted chemical reaction). Non-limiting examples of the conductive material may include a carbon-based material (such as natural graphite, artificial graphite, carbon black, acetylene black, Ketjenblack®, a carbon fiber and/or the like); a metal-based material of a metal powder or a metal fiber including copper, nickel, aluminum, silver, and/or the like; a conductive polymer (such as a polyphenylene derivative); or a mixture thereof.

The current collector may be Al, but embodiments of the present disclosure are not limited thereto.

Another embodiment of the present disclosure provides a rechargeable lithium battery including a positive electrode including a positive active material and Fe, a negative electrode including a negative active material, and an electrolyte. Herein, the Fe content may be about 0.005 wt % to about 3 wt %, and in some embodiments about 0.02 wt % to about 1 wt % based on 100 wt % of the positive active material.

The rechargeable lithium battery may be manufactured using the aforementioned positive electrode (e.g., a positive electrode including a current collector and a positive active material layer formed on the current collector and including the positive active material and the Fe-containing oxide, wherein the Fe-containing oxide is used in an amount of about 0.015 parts by weight to about 8.5 parts by weight based on 100 parts by weight of the positive active material), and by performing 1 to 3 charge/discharge cycles at about 0.05 C (e.g., C/20) to about 0.1 C (e.g., C/10).

When the battery manufactured using the positive electrode including the Fe-containing oxide (e.g., the unused positive electrode prior to formation and cycling) is charged and discharged 1 to 3 times at about 0.05 C to about 0.1 C (e.g., during a formation process), the Fe-containing oxide may decompose and remain as Fe in the final battery.

The negative electrode may include a current collector and a negative active material layer including a negative active material on the current collector.

The negative active material may include a material that reversibly intercalates/deintercalates lithium ions, a lithium metal, a lithium metal alloy, a material capable of doping/dedoping lithium, and/or a transition metal oxide.

The material that can reversibly intercalate/deintercalate lithium ions may include a carbon material. The carbon material may be any carbon-based negative active material for a lithium ion rechargeable battery available in the related art. Non-limiting examples of the carbon material may include crystalline carbon, amorphous carbon, and mixtures thereof. The crystalline carbon may be shapeless, or may be a sheet, flake, spherical, or fiber shaped natural graphite or artificial graphite. The amorphous carbon may be a soft carbon, a hard carbon, a mesophase pitch carbonization product, fired coke, and/or the like.

The lithium metal alloy may include lithium and an element selected from sodium (Na), potassium (K), rubidium (Rb), cesium (Cs), francium (Fr), beryllium (Be), magnesium (Mg), calcium (Ca), strontium (Sr), silicon (Si), antimony (Sb), lead (Pb), indium (In), zinc (Zn), barium (Ba), radium (Ra), germanium (Ge), aluminum (Al), and tin (Sn).

The material capable of doping/dedoping lithium may include Si, a Si—C composite, SiOₓ (0<x<2), a Si-Q alloy (wherein Q is an element selected from an alkali metal, an alkaline-earth metal, a Group 13 element, a Group 14 element excluding Si, a Group 15 element, a Group 16 element, a transition element, a rare earth element, and combinations thereof), Sn, SnO₂, a Sn—R alloy (wherein R is an element selected from an alkali metal, an alkaline-earth metal, a Group 13 element, a Group 14 element excluding Sn, a Group 15 element, a Group 16 element, a transition element, a rare earth element, and combinations thereof), and/or the like. At least one of these materials may be mixed with SiO₂. The elements Q and R may be selected from Mg, Ca, Sr, Ba, Ra, scandium (Sc), yttrium (Y), titanium (Ti), zirconium (Zr), hafnium (Hf), rutherfordium (Rf), vanadium (V), niobium (Nb), tantalum (Ta), dubnium (Db), chromium (Cr), molybdenum (Mo), tungsten (W), seaborgium (Sg), technetium (Tc), rhenium (Re), bohrium (Bh), iron (Fe), lead (Pb), ruthenium (Ru), osmium (Os), hassium (Hs), rhodium (Rh), iridium (Ir), palladium (Pd), platinum (Pt), copper (Cu), silver (Ag), gold (Au), zinc (Zn), cadmium (Cd), boron (B), Al, gallium (Ga), Sn, In, thallium (Tl), Ge, phosphorus (P), arsenic (As), Sb, bismuth (Bi), sulfur (S), selenium (Se), tellurium (Te), polonium (Po), and a combination thereof.

The transition metal oxide may include vanadium oxide, lithium vanadium oxide, and/or the like.

According to an embodiment of the present disclosure, when the carbon-based negative active material is used as a negative active material, battery capacity may be maximized by configuring the positive electrode according to an embodiment of the present disclosure to maximize the Li utilization ratio.

In the negative active material layer, the negative active material may be used in an amount of about 95 wt % to about 99 wt % based on the entire weight of the negative active material layer.

According to an embodiment of the present disclosure, the negative active material layer includes a binder and optionally a conductive material. The negative active material layer may include about 1 wt % to about 5 wt % of a binder based on the total weight of the negative active material layer. When the negative active material layer includes a conductive material, the negative active material layer may include about 90 wt % to about 98 wt % of the negative active material, about 1 wt % to about 5 wt % of the binder, and about 1 wt % to about 5 wt % of the conductive material.

The binder may improve the binding properties of the negative active material particles with one another and with a current collector. The binder may include a non-water-soluble binder, a water-soluble binder, or a combination thereof.

The non-water-soluble binder may include polyvinylchloride, carboxylated polyvinylchloride, polyvinyl fluoride, an ethylene oxide-containing polymer, polyvinylpyrrolidone, polyurethane, polytetrafluoroethylene, polyvinylidene fluoride, polyethylene, polypropylene, polyamideimide, polyimide, or a combination thereof.

The water-soluble binder may be a rubber-based binder or a polymer resin binder. The rubber-based binder may be selected from a styrene-butadiene rubber, an acrylated styrene-butadiene rubber (SBR), an acrylonitrile-butadiene rubber, an acrylic rubber, a butyl rubber, a fluorine rubber, and combinations thereof. The polymer resin binder may be selected from an ethylene propylene copolymer, polyepichlorohydrin, polyphosphazene, polyacrylonitrile, polystyrene, ethylene propylenediene copolymer, polyvinylpyridine, chlorosulfonated polyethylene, latex, a polyester resin, an acrylic resin, a phenolic resin, an epoxy resin, polyvinyl alcohol, and combinations thereof.

When the water-soluble binder is used as a negative electrode binder, a cellulose-based compound may be further used as an agent for increasing viscosity. The cellulose-based compound may include one or more of carboxymethyl cellulose, hydroxypropylmethyl cellulose, methyl cellulose, or alkali metal salts thereof. The alkali metal may be Na, K, or Li. The agent for increasing viscosity may be included in an amount of about 0.1 to about 3 parts by weight based on 100 parts by weight of the negative active material.

The conductive material may be included to provide electrode conductivity. Any electrically conductive material may be used as a conductive material unless it causes a chemical change (e.g., unwanted chemical reaction). Non-limiting examples of the conductive material may include a carbon-based material (such as natural graphite, artificial graphite, carbon black, acetylene black, Ketjenblack®, a carbon fiber, and/or the like); a metal-based material of a metal powder or a metal fiber including copper, nickel, aluminum, silver, and/or the like; a conductive polymer (such as a polyphenylene derivative); or a mixture thereof.

The current collector may include one selected from a copper foil, a nickel foil, a stainless steel foil, a titanium foil, a nickel foam, a copper foam, a polymer substrate coated with a conductive metal, and combinations thereof, but embodiments of the present disclosure are not limited thereto.

The negative electrode and the positive electrode may be respectively manufactured by mixing each active material, a conductive material, and a binder in a solvent to prepare two active material compositions, and coating each composition on a current collector. Electrode manufacturing methods are well known, and are thus not described in more detail in the present specification. The solvent may include N-methylpyrrolidone and/or the like, but embodiments of the present disclosure are not limited thereto. When the negative electrode uses a water-soluble binder, the solvent for preparing a negative active composition may be water.

The electrolyte may include a non-aqueous organic solvent and a lithium salt.

The non-aqueous organic solvent may serve as a medium for transmitting ions taking part in the electrochemical reactions of a battery.

The organic solvent may include a carbonate-based, ester-based, ether-based, ketone-based, alcohol-based, or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. The ester-based solvent may include methyl acetate, ethyl acetate, n-propyl acetate, dimethylacetate, methylpropionate, ethylpropionate, decanolide, mevalonolactone, caprolactone, and/or the like. The ether-based solvent may be dibutyl ether, tetraglyme, diglyme, dimethoxyethane, 2-methyltetrahydrofuran, tetrahydrofuran, and/or the like. The ketone-based solvent may be cyclohexanone and/or the like. The alcohol based solvent may include ethyl alcohol, isopropyl alcohol, and/or the like, and the aprotic solvent may include nitriles (such as R—CN, where R is a C₂ to C₂₀ linear, branched, or cyclic hydrocarbon having a double bond, an aromatic ring, or an ether bond), amides (such as dimethylformamide), dioxolanes (such as 1,3-dioxolane), sulfolanes, and/or the like.

The organic solvent may be single solvent or a mixture of solvents. When the organic solvent is a mixture of solvents, the mixture ratio may be controlled or selected in accordance with desirable or suitable battery performance.

The carbonate-based solvent may include a mixture with a cyclic carbonate and a linear carbonate. The cyclic carbonate and linear carbonate may be mixed together in a volume ratio of about 1:1 to about 1:9. When the mixture is used as an electrolyte, it may have enhanced performance.

The organic solvent may further include an aromatic hydrocarbon-based solvent as well as the carbonate-based solvent. The carbonate-based solvent and aromatic hydrocarbon-based solvent may be mixed together in a volume ratio of about 1:1 to about 30:1.

The aromatic hydrocarbon-based organic solvent may be an aromatic hydrocarbon-based compound represented by Chemical Formula 2:

### Chemical Formula 2

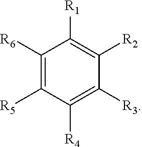

In Chemical Formula 2, R₁ to R₆ may each be the same or different, and may be selected from hydrogen, a halogen (e.g., a halogen atom), a C₁ to C₁₀ alkyl group, a haloalkyl group, and combinations thereof.

Non-limiting examples of the aromatic hydrocarbon-based organic solvent may be selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and combinations thereof.

The electrolyte may further include an additive for improving cycle-life (such as vinylene carbonate and/or the ethylene carbonate-based compound represented by Chemical Formula 3):

### Chemical Formula 3

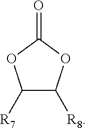

In Chemical Formula 3, R₇ and R₈ may each be the same or different and may each independently be hydrogen, a halogen (e.g., a halogen atom), a cyano group (CN), a nitro group (NO₂), or a C₁ to C₅ fluoroalkyl group, provided that at least one of R₇ and R₈ is a halogen, a cyano group (CN), a nitro group (NO₂), or a C₁ to C₅ fluoroalkyl group, and R₇ and R₈ are not both (e.g., simultaneously) hydrogen.

Non-limiting examples of the ethylene carbonate-based compound may include difluoroethylene carbonate, chloroethylene carbonate, dichloroethylene carbonate, bromoethylene carbonate, dibromoethylene carbonate, nitroethylene carbonate, cyanoethylene carbonate, fluoroethylene carbonate, and the like.

The amount of the additive for improving cycle life may be flexible within an appropriate or suitable range.

The lithium salt dissolved in the organic solvent supplies a battery with lithium ions, is basically essential in the rechargeable lithium battery, and may improve lithium ion transport between the positive and negative electrodes. Non-limiting examples of the lithium salt may include at least one supporting salt selected from LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiN(CₓF₂ₓ₊₁SO₂)(C_{y}F_{2y+1}SO₂) (where x and y are natural numbers, e.g. an integer selected from 1 to 20), LiCl, LiI, and LiB(C₂O₄)₂ (lithium bis(oxalato) borate; LiBOB). The lithium salt may be used in a concentration of about 0.1 M to about 2.0 M. When the lithium salt is included at the above concentration range, the electrolyte may have excellent performance and lithium ion mobility due to optimal electrolyte conductivity and viscosity.

The rechargeable lithium battery may further include a separator between the negative electrode and the positive electrode, depending on the kind or type of battery. Non-limiting examples of suitable separator material may include polyethylene, polypropylene, polyvinylidene fluoride, and multi-layer materials thereof (such as a polyethylene/polypropylene double-layered separator, a polyethylene/polypropylene/polyethylene triple-layered separator, and/or a polypropylene/polyethylene/polypropylene triple-layered separator).

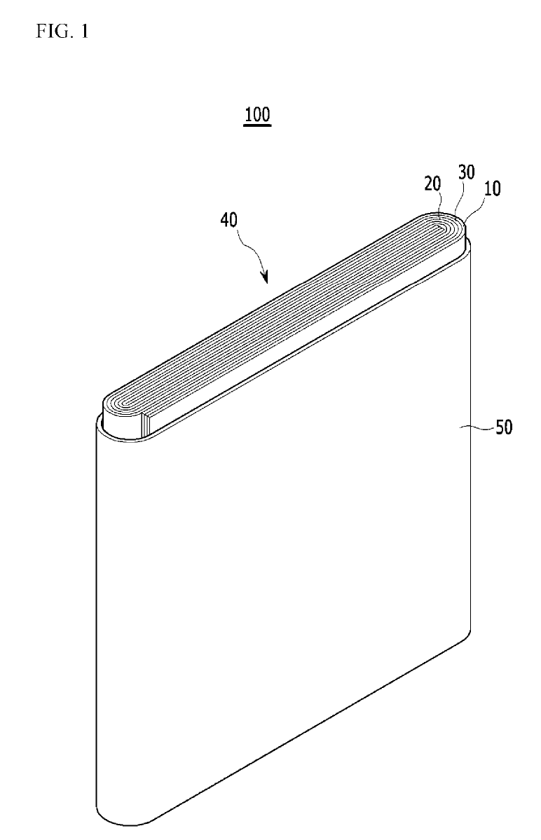

FIG. 1 is an exploded perspective view showing a rechargeable lithium battery according to an embodiment of the present disclosure. The rechargeable lithium battery according to an embodiment of the present disclosure is illustrated as a prismatic rechargeable lithium battery, but embodiments of the present disclosure are not limited thereto and may include one or more suitably-shaped batteries (such as a cylindrical battery, a pouch battery, and/or the like).

Referring to FIG. 1, a rechargeable lithium battery 100 according to an embodiment of the present disclosure includes an electrode assembly 40 manufactured by winding a separator 30 interposed between a positive electrode 10 and a negative electrode 20, and a case 50 housing the electrode assembly 40. An electrolyte may be impregnated in the positive electrode 10, the negative electrode 20, and the separator 30.

Hereinafter, examples of the present disclosure and comparative examples are described. These examples, however, are not in any sense to be interpreted as limiting the scope of the present disclosure.

### Preparation Example 1

Li₂CO₃ and Co₃O₄ were mixed to have a Li:Co mole ratio of 1:1 in a final product, and this mixture was fired at 1100° C. under an air atmosphere for 10 hours to manufacture LiCoO₂.

This LiCoO₂ was pulverized to prepare a LiCoO₂ positive active material having an average particle diameter (D50) of 20 μm.

### Preparation Example 2

LiOH.H₂O and Fe₂O₃ were mixed to have a Li:Fe mole ratio of 5:1 in a final product, and this mixture was fired at 700° C. under an N₂ atmosphere for 10 hours to manufacture Li₅FeO₄.

The Li₅FeO₄ was pulverized to prepare Li₅FeO₄ having an average particle diameter (D50) of 2 μm.

### Example 1

The LiCoO₂ positive active material according to Preparation Example 1 and the Li₅FeO₄ according to Preparation Example 2 were mixed in a ratio of 100:0.8 parts by weight. 96 wt % of the mixture, 2 wt % of polyvinylidene fluoride, and 2 wt % of Ketjenblack® were mixed in an N-methyl pyrrolidone solvent to prepare positive active material slurry.

The positive active material slurry was coated on an Al current collector and then dried and compressed to manufacture a positive electrode for a rechargeable lithium battery.

### Example 2

A positive electrode for a rechargeable lithium battery was manufactured according to substantially the same method as Example 1, except for mixing the LiCoO₂ positive active material and the Li₅FeO₄ in a ratio of 100:1.6 parts by weight.

### Example 3

A positive electrode for a rechargeable lithium battery was manufactured according to substantially the same method as Example 1, except for mixing the LiCoO₂ positive active material and the Li₅FeO₄ in a ratio of 100:4.9 parts by weight.

### Example 4

A positive electrode for a rechargeable lithium battery was manufactured according to substantially the same method as Example 1, except for mixing the LiCoO₂ positive active material and the Li₅FeO₄ in a ratio of 100:8.3 parts by weight.

### Example 5

A positive electrode for a rechargeable lithium battery was manufactured according to substantially the same method as Example 1, except for mixing the LiCoO₂ positive active material and the Li₅FeO₄ in a ratio of 100:3 parts by weight.

### Example 6

A positive electrode for a rechargeable lithium battery was manufactured according to substantially the same method as Example 1, except for mixing the LiCoO₂ positive active material and the Li₅FeO₄ in a ratio of 100:3.5 parts by weight.

### Example 7

A positive electrode for a rechargeable lithium battery was manufactured according to substantially the same method as Example 1, except for mixing the LiCoO₂ positive active material and the Li₅FeO₄ in a ratio of 100:4 parts by weight.

### Example 8

A positive electrode for a rechargeable lithium battery was manufactured according to substantially the same method as Example 1, except for mixing the LiCoO₂ positive active material and the Li₅FeO₄ in a ratio of 100:5.5 parts by weight.

### Example 9

A positive electrode for a rechargeable lithium battery was manufactured according to substantially the same method as Example 1, except for mixing the LiCoO₂ positive active material and the Li₅FeO₄ in a ratio of 100:6.3 parts by weight.

### Example 10

A positive electrode for a rechargeable lithium battery was manufactured according to substantially the same method as Example 1, except for mixing the LiCoO₂ positive active material and the Li₅FeO₄ in a ratio of 100:7 parts by weight.

### Comparative Example 1

96 wt % of the LiCoO₂ positive active material according to Preparation Example 1, 2 wt % of polyvinylidene fluoride, and 2 wt % of Ketjenblack® were mixed in an N-methyl pyrrolidone solvent to prepare a positive active material slurry.

The positive active material slurry was coated on an Al current collector, and then dried and compressed to manufacture a positive electrode for a rechargeable lithium battery.

### Comparative Example 2

A positive electrode for a rechargeable lithium battery was manufactured according to substantially the same method as Example 1, except for mixing the LiCoO₂ positive active material and the Li₅FeO₄ in a weight ratio of 100:17.65 parts by weight.

### Comparative Example 3

A positive electrode for a rechargeable lithium battery was manufactured according to substantially the same method as Example 1, except for mixing the LiCoO₂ positive active material and the Li₅FeO₄ in a weight ratio of 100:11.9 parts by weight.

### Comparative Example 4

A positive electrode for a rechargeable lithium battery was manufactured according to substantially the same method as Example 1, except for mixing the LiCoO₂ positive active material and the Li₅FeO₄ in a weight ratio of 100:9 parts by weight.

### Comparative Example 5

A positive electrode for a rechargeable lithium battery was manufactured according substantially to the same method as Example 1, except for mixing the LiCoO₂ positive active material and the Li₅FeO₄ in a weight ratio of 100:10 parts by weight.

### Measurement of Fe Content

98 wt % of artificial graphite and 2 wt % of polyvinylidene fluoride were mixed in an N-methyl pyrrolidone solvent to prepare negative active material slurry.

The negative active material slurry was coated on a Cu current collector, and then dried and compressed to manufacture a negative electrode for a rechargeable lithium battery.

The negative electrode, each positive electrode according to Examples 1 to 4 and Comparative Examples 1 to 3, and an electrolyte solution were used to manufacture a rechargeable lithium battery cell. Herein, the electrolyte solution was prepared by dissolving 1.0 M LiP F₆ in a mixed solvent of ethylene carbonate and diethyl carbonate (7:3 of a volume ratio).

The rechargeable lithium battery cell was charged and discharged once at 0.1 C to perform a formation process. After the formation process, the Fe content included in each positive electrode was measured via an ICP (Inductively Coupled Plasma) method, and the results were converted into units of mol % and wt %, as shown in Table 1:

TABLE 1

| | Fe Content (mol %) (wt %) |
|---|---|
| Example 1 | 0.495 mol % (0.3 wt %) |
| Example 2 | 1.015 mol % (0.58 wt %) |
| Example 3 | 2.983 mol % (1.8 wt %) |
| Example 4 | 4.871 mol % (3 wt %) |
| Comparative Example 1 | 0.008 mol % (0.001 wt %) |
| Comparative Example 2 | 14.92 mol % (10 wt %) |
| Comparative Example 3 | 6.910 mol % (4.3 wt %) |

### Battery Characteristics Evaluation

After the formation process, each rechargeable lithium battery cell was charged and discharged once at 3.0 V to 4.55 V and 0.1 C, its charge and discharge capacity and initial coulombic efficiency (ICE, formation efficiency) were measured, and the results are shown in Table 2:

TABLE 2

| | Charge capacity | Discharge capacity | ICE |
|---|---|---|---|
| | (mAh/g) | (mAh/g) | (%) |
| Example 1 | 200 | 186 | 92.6 |
| Example 2 | 203 | 188 | 92.7 |
| Example 3 | 213 | 188 | 88.4 |
| Example 4 | 223 | 184 | 82.7 |
| Example 5 | 233 | 180 | 77.5 |
| Comparative Example 1 | 198 | 183 | 92.4 |
| Comparative Example 2 | 272 | 165 | 60.5 |

### Utilization Ratio Measurement of Positive Electrode

98 wt % of artificial graphite and 2 wt % of polyvinylidene fluoride were mixed in an N-methyl pyrrolidone solvent to prepare a negative active material slurry.

The negative active material slurry was coated on a Cu current collector, and then dried and compressed to manufacture a negative electrode for a rechargeable lithium battery cell.

The negative electrode, each positive electrode according to Examples 1 to 10 and Comparative Examples 1, 4, and 5, and an electrolyte solution were used to manufacture a rechargeable lithium battery cell. Herein, the electrolyte solution was prepared by dissolving 1.0 M LiP F₆ in a mixed solvent of ethylene carbonate and diethyl carbonate (7:3 of a volume ratio).

The manufactured battery cells were used to measure a capacity utilization ratio.

The capacity utilization ratio was measured by charging the cells at a rate of 0.2 C using a CC/CV (a constant current/constant voltage) protocol up to about 4.45 V and then measuring the charge capacity, discharging the cells at a rate of 0.2 C using a CC protocol down to 3.0 V, and then measuring the discharge capacity, then dividing the discharge capacity by the charge capacity.

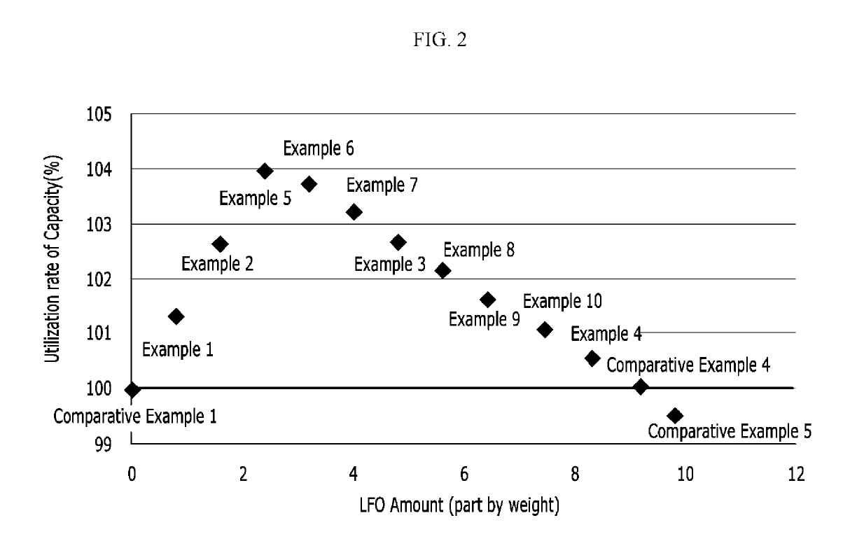

The results are shown in FIG. 2. In FIG. 2, the LFO content indicates a mixing ratio of the Li₅FeO₄ based on 100 parts by weight of the LiCoO₂ positive active material. As shown in FIG. 2, the cells using the positive electrodes according to Examples 1 to 10 using 0.8 to 8.3 parts by weight of the Li₅FeO₄ based on 100 parts by weight of the LiCoO₂ positive active material exhibited an excellent capacity utilization ratio compared with the cell using the positive electrode according to Comparative Example 1 using no Li₅FeO₄ and the cells using the positive electrodes Comparative Examples 4 and 5 using the Li₅FeO₄ in an excessive amount.

As used herein, expressions such as “at least one of”, “one of”, and “selected from”, when preceding a list of elements, modify the entire list of elements and do not modify the individual elements of the list. Further, the use of “may” when describing embodiments of the present disclosure refers to “one or more embodiments of the present disclosure”.

In addition, as used herein, the terms “use”, “using”, and “used” may be considered synonymous with the terms “utilize”, “utilizing”, and “utilized”, respectively.

As used herein, the terms “substantially”, “about”, and similar terms are used as terms of approximation and not as terms of degree, and are intended to account for the inherent deviations in measured or calculated values that would be recognized by those of ordinary skill in the art.

Also, any numerical range recited herein is intended to include all subranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

While this disclosure has been described in connection with what is presently considered to be practical example embodiments, it is to be understood that the present disclosure is not limited to the disclosed embodiments, but, on the contrary, is intended to cover various modifications and equivalent arrangements included within the spirit and scope of the following claims and equivalents thereof.

What is claimed is:

1. A positive electrode for a rechargeable lithium battery, comprising:
a current collector; and
a positive active material layer on the current collector,
wherein the positive active material layer includes a positive active material and a Fe-containing oxide, and the Fe-containing oxide is included in an amount of about 0.015 parts by weight to about 8.5 parts by weight based on 100 parts by weight of the positive active material.

2. The positive electrode of claim 1, wherein the Fe-containing oxide is Li₅FeO₄, LiFeO₂, LiFe₅O₈, or a combination thereof.

3. The positive electrode of claim 1, wherein the positive active material layer includes about 0.08 parts by weight to about 4.0 parts by weight of the Fe-containing oxide per 100 parts by weight of the positive active material.

4. The positive electrode of claim 1, wherein the Fe-containing oxide has a particle diameter (D50) of about 0.5 μm to about 3 μm.

5. The positive electrode of claim 1, wherein the positive active material is a compound represented by Chemical Formula 1:
LiₐCo_{1-b}M_{b}O₂, [Chemical Formula 1]
wherein in Chemical Formula 1, 0.90≦a≦0≦b≦0.5, and M is selected from Al, Ni, Co, Mn, Cr, Fe, Mg, Sr, V, a rare earth element, and a combination thereof.

6. A rechargeable lithium battery, comprising:
a positive electrode including a positive active material and Fe;
a negative electrode including a negative active material; and
an electrolyte,
wherein the Fe is included in an amount of about 0.005 wt % to about 3 wt % based on 100 wt % of the positive active material.

7. The rechargeable lithium battery of claim 6, wherein the rechargeable lithium battery includes a positive electrode including a current collector and a positive active material layer on the current collector, wherein the positive active material layer includes the positive active material and an Fe-containing oxide, and the Fe-containing oxide is included in an amount of about 0.015 parts by weight to about 8.5 parts by weight based on 100 parts by weight of the positive active material, and the rechargeable lithium battery is manufactured by performing 1 to 3 charge/discharge cycles at about 0.05 C to about 0.1 C.

8. The rechargeable lithium battery of claim 6, wherein the negative active material is a carbon-based negative active material.

9. The rechargeable lithium battery of claim 6, wherein the positive active material is a compound represented by Chemical Formula 1:
LiₐCo_{1-b}M_{b}O₂, [Chemical Formula 1]
wherein in Chemical Formula 1, 0.90≦a≦0≦b≦0.5, and M is selected from Al, Ni, Co, Mn, Cr, Fe, Mg, Sr, V, a rare earth element, and a combination thereof.
